(19) United States
(12) Patent Application Publication
(10) Pub. No.: US 2014/0012447 A1
(43) Pub. Date: Jan. 9, 2014

(54) THERMAL MANAGEMENT OF VEHICLE BATTERY PACK DURING CHARGING

(71) Applicant: Magna E-Car Systems of America, Inc., Auburn Hills, MI (US)

(72) Inventors: Guangning Gao, Rochester Hills, MI (US); Ibrahim Alkeilani, Auburn Hills, MI (US)

(21) Appl. No.: 13/928,488

(22) Filed: Jun. 27, 2013

Related U.S. Application Data
(60) Provisional application No. 61/667,868, filed on Jul. 3, 2012.

(51) Int. Cl. B60L 11/18

(52) U.S. Cl. CPC B60L 11/1874
USPC 701/22

(57) ABSTRACT

A process for charging a battery pack of a vehicle is provided. The vehicle has a cooling system that automatically turns on to cool the battery pack when its temperature reaches a high threshold temperature. The process involves determining an operating heating rise of the battery pack in the event the vehicle is driven at a predetermined operating condition. The process determines a target temperature for the battery pack at the end of charging which is set to prevent the cooling system from turning on if the vehicle is driven under the predetermined operating condition. The battery pack is then charged and the cooling system is operated during charging to prevent the battery pack from reaching the target temperature. By preventing the subsequent operation of the cooling system, the driving range provided by the battery pack may be extended.

### CROSS-REFERENCE TO RELATED APPLICATIONS

This application claims the benefit of U.S. Provisional Application No. 61/667,868 filed Jul. 3, 2012. The entire disclosure of the above application is incorporated herein by reference.

### FIELD

The present disclosure relate generally to the field of electric and hybrid electric vehicles and, more particularly, to the thermal management of the battery pack in such vehicles.

### BACKGROUND

This section provides background information related to the present disclosure which is not necessarily prior art.

A roadblock to the widespread adoption of electric vehicles (EVs) is their limited range and the relatively long time required to recharge the battery pack. Level 3 charging capability, such as provided by CHAdeMO™ type charging stations, attempts to address these issues by utilizing high voltage (e.g., 400-500 Volt DC) and high current (e.g., up to 125 Amperes) chargers to reduce charging time. With Level 3 charging, it is anticipated that a typical electric vehicle can be charged from about a 20% state of charge (SOC) to about an 80% state of charge in about 30-45 minutes. With future deployment of Level 3 charging infrastructure, electric vehicles will become more suitable for long trips.

However, the charging and discharging of the battery pack is also a thermal event that should be managed properly. For example, lithium based batteries, which are the most popular choice for electric vehicles, have limited operating temperature ranges. It would be desirable not only to ensure that the battery pack does not exceed operating temperature limits under Level 3 charging, but also to charge the battery pack in such a manner that the entire drive cycle of the electric vehicle is taken into consideration.

For example, consider the situation where an electric vehicle reaches a Level 3 fast charging station after a one hour drive in hot weather. The temperature of the battery pack may be near or at an upper operating temperature limit, e.g., 45 degrees Celsius. When the Level 3 charging begins, the heat generation from the high current (up to 125 A) into the battery pack can heat the battery pack quickly. With a conventional thermal management strategy, the on-board cooling system will not run to cool the battery until the temperature of the battery pack reaches a high threshold temperature, e.g., 43 degrees Celsius. But, on a hot day, with a significant amount of heat being generated from the high current charging, and with the efficiency of the battery cooling system not being at its most optimal given that the vehicle is in park, the cooling capacity of the on-board cooling system may be insufficient to keep the temperature of the battery pack under the upper operating temperature limit. Under some conditions, the temperature of the battery pack may continue to increase and eventually reach a point at which the high power, Level 3 fast charging has to be degraded or inhibited.

Another concern arises when the Level 3 charging finishes. The conventional thermal management strategy will attempt to keep the temperature of the battery pack just under the high threshold temperature for safety purposes. However, as the battery pack is relatively hot to begin with, the heat generated by operating the battery pack at high speed and the heat transferred from the environment may increase the temperature of the battery pack up to the upper operating temperature limit after a relatively short period (e.g., about 15 minutes) of highway speed driving. Then the electric vehicle will be forced to run the on-board cooling system to cool the battery pack. The energy consumed by the cooling system will shorten the available driving range and hence frustrate some of the benefits provided by the Level 3 fast charging capability.

In view of the above-noted shortcomings, a better thermal management strategy is desired that takes into consideration the entire drive cycle of the electric vehicle with the goal of increasing range.

### SUMMARY

This section provides a general summary of the disclosure, and is not intended to be a comprehensive disclosure of its full scope or all of its features.

According to one aspect of the present disclosure, a charging method or process for charging a battery pack of a vehicle is provided. The charging process may include: (i) determining an operating heating rise of the battery pack in the event the vehicle is driven at a predetermined operating condition; (ii) obtaining a charging time to charge the battery pack; (iii) determining a terminal avoidance temperature for the battery pack at the end of the charge time where the terminal avoidance temperature is no greater than an upper threshold temperature less the operating heating rise, and where the upper threshold is a temperature at which a cooling system of the vehicle automatically turns on to cool the battery pack; and (iv) charging the battery pack and operating the cooling system during charging to prevent the battery pack from reaching the terminal avoidance temperature.

In accordance with another aspect of the present disclosure, the charging process may also include providing (i) a heating performance of the battery pack while under charge; (ii) the operating heating rise of the battery pack in the event the vehicle is driven at the predetermined operating condition; and (iii) a cooling performance of the cooling system in cooling the battery pack when the vehicle is parked. The step of operating the cooling system may also include: estimating a lower starting battery temperature based on the terminal avoidance temperature less a temperature rise predicted by the heating performance of the battery pack while charging the battery pack for the duration of the charging; time; measuring the temperature of the battery pack at the commencement of charging; and, based on the lower starting battery temperature and the cooling performance of the cooling system, determining when, if at all, to operate the cooling system whilst charging to cool the battery pack.

According to yet another aspect of the present disclosure, the charger may have at least a fast constant current charging phase and a slow constant voltage charging phase. In the fast constant current phase, the battery pack may be charged with a constant current of at least 80 Amperes.

In accordance with at least one of the aspects, the predetermined condition may be driving the vehicle at a predetermined speed for a predetermined period of time.

In another aspect of the present disclosure, a charging system is provided for use with a vehicle having a battery pack driving an electric motor. The charging system includes a cooling system for cooling at least the battery pack. A controller determines (i) an operating heating rise of the battery pack in the event the vehicle is driven at a predetermined operating condition; (ii) a charging time to charge the battery pac; and (iii) a terminal avoidance temperature for the battery pack at the end of the charge time, wherein the terminal avoidance temperature is no greater than an upper threshold temperature less the operating heating rise, and wherein the upper threshold is a temperature at which a cooling system of the vehicle automatically turns on to cool the battery pack. The controller operates the cooling system during charging to prevent the battery from reaching the terminal avoidance temperature.

In accordance with at least one aspect of the present disclosure, the controller may include (i) a thermal model of a heating performance of the battery pack while under charge, (ii) the operating heating rise of the battery pack in the event the vehicle is driven at the predetermined operating condition, and (iii) a cooling performance of the cooling system in cooling the battery pack when the vehicle is parked. The controller may estimate a lower starting battery temperature based on the terminal avoidance temperature less a temperature rise predicted by the heating performance of the battery while charging the battery for the duration of the charging time. The controller may also measure the temperature of the battery pack at the commencement of charging and, based on the lower starting battery temperature and the cooling performance of the cooling system, determines if and when to operate the cooling system whilst charging to cool the battery pack.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The foregoing and other aspects will now be described by way of example only with reference to the attached drawings, in which:

FIG. 1 is a schematic block diagram of an electric vehicle configured in accordance with the teachings of the present disclosure;

FIG. 2A is a flowchart showing the steps of a first portion of a charging process; and

FIG. 2B is a flowchart showing the steps of an optional second portion of the charging process.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not to be employed, that example embodiments may be embodied in many different forms and that neither should be constructed to limit the scope of the disclosure. In some example embodiments, well-known processes, well-known device structures, and well-known technologies are not described in detail.

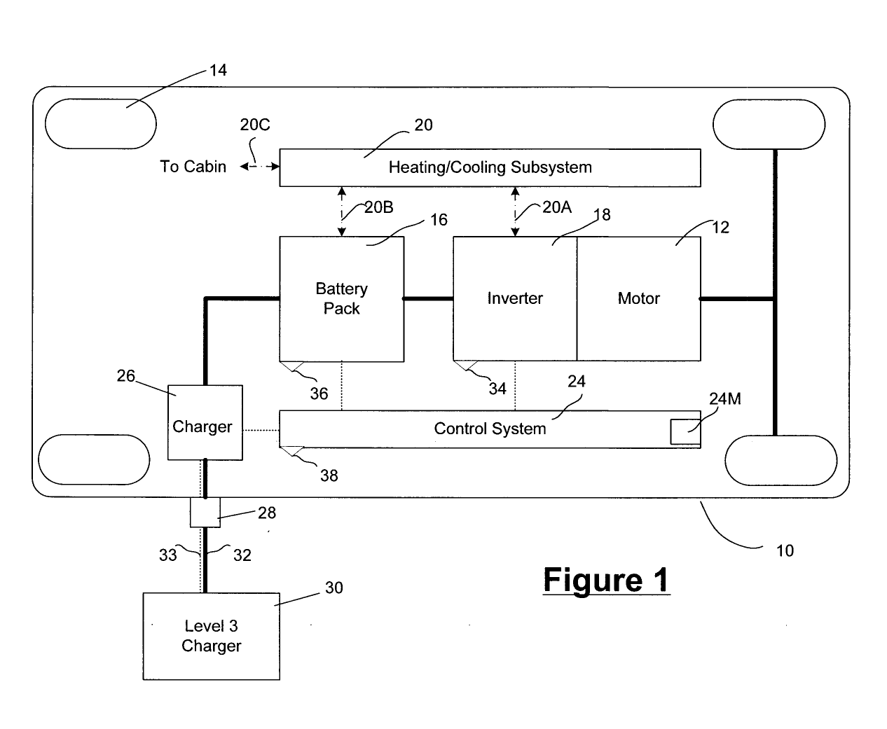

Reference is made to FIG. 1 in which a schematic block diagram of an electric vehicle 10 is shown. The term ‘electric vehicle’ as used herein denotes a vehicle that includes an electric traction motor (which may be referred to simply as an ‘electric motor’ for convenience). The electric vehicle 10 may also include an internal combustion engine, or alternatively it may lack an internal combustion engine. In embodiments wherein an internal combustion engine is provided, the engine may be operated simultaneously with the electric traction motor (parallel hybrid), or it may be operated only when the battery pack for the electric traction motor has been substantially depleted (or depleted to a minimum acceptable state of charge). In embodiments wherein the engine is provided, the function of the engine may be to propel the vehicle, to charge the battery pack, both propelling the vehicle and charging the battery pack, or for some other reason. Furthermore, the electric vehicle 10 may be any suitable type of vehicle, such as, for example, an automobile, a truck, an SUV, a bus, a van or any other type of vehicle. The electric vehicle 10 includes an electric motor 12 that drives one or more wheels 14. The electric motor 12 is powered by an on-board battery pack 16 through an inverter 18 which is connected between the battery pack 16 and the electric motor 12. The inverter 18 functions to pulse width modulate the voltage applied to the electric motor 12 from the battery pack 16 and thus controls the current applied to the electric motor 12 and hence the torque produced by the electric motor 12 to propel the wheels 14. The electric vehicle 10 may also include one or more regeneration systems (not shown) as known in the art.

The electric motor 12, the inverter 18 and the battery pack 16 are also connected to a heating/cooling subsystem 20 which operates to heat and/or cool the battery pack 16, the inverter 18 and the electric motor 12 as required. The heating/cooling subsystem 20 includes a temperature sensor 34 for the inverter 18 and the electric motor 12, a temperature sensor 36 for the battery pack 16 and a temperature sensor 38 for sensing the temperature of the ambient environment. In the heating/cooling subsystem 20 shown in FIG. 1, the electric motor 12 and inverter 18 are positioned in one thermal loop 20A, the battery pack 16 is positioned in a second thermal loop 20B and the passenger cabin is positioned in a third thermal loop 20C. The thermal loops 20A, 20B and 20C are all integrated so that energy from one thermal loop can be transferred to another thermal loop. An example of such an integrated heating/cooling subsystem 20 is described in PCT publication WO2012040022, the contents of which are incorporated herein in their entirety. However, those skilled in the art will understand that the thermal loops 20A, 20B and 20C may all be independent of one another, and from what follows, it will be understood that the focus of this disclosure is on the battery thermal loop 20B for heating and/or cooling the battery pack 16.

In some embodiments, the heating/cooling subsystem 20 may simply be referred to as a cooling system 20, since, for the purposes described herein, the system 20 is described principally in relation to its ability to cool vehicle components (e.g. the battery pack 16).

A vehicle control system 24 is connected to the electric motor 12, the inverter 18 and battery pack 16 and provides control signals to them in order to control the electric vehicle 10 pursuant to the driver's commands and to other embedded control logic.

An on-board charger 26 is connected to charge the battery pack 16 and connected to the controller 24. The on-board charger 26 is provided for level 1 or level 2 re-charging of the battery pack 16, e.g., using the standard 120V AC wall outlet power or via a 3-phase, 240 Volt power connection. For level 3 charging, control of the delivery of current to the battery 28 may be handled by an external Level 3 charger 30.

The vehicle control system 24 controls the heating/cooling subsystem 20 and also receives the signal line 33 so as to be able to communicate with the Level 3 charger 30. Persons skilled in the art will understand that the vehicle control system 24 may be implemented in a distributed manner where a number of microcontrollers, each having embedded control logic, communicate with one another or with a master controller over a controller area network. For example, the vehicle control system 24 may include a microcontroller with embedded control logic to manage various pumps, valves, compressors, chillers, heaters and other such components of the heating/cooling subsystem 20 in conjunction with a master microcontroller that controls high level operational aspects of the electric vehicle 10. In addition, the vehicle control system 24 may include another microcontroller with embedded control logic to manage the on-board charger 26 and to communicate with the Level 3 charger 30 in conjunction with high level commands from the master controller. In this example, the microcontroller responsible for the heating/cooling subsystem 20 may communicate with the microcontroller responsible for charging in order to carry out charging processes such as those processes described below.

Conventionally, the Level 3 charger 30 follows a three stage charging process. In a first stage, when the state of charge of the battery pack 16 is quite low, e.g., about 5 to about 15%, the Level 3 charger 30 charges the battery pack 16 with an extremely high constant current for a relatively short period of time, e.g., at about 125 Amps for about 10 minutes. In a following stage, the Level 3 charger 30 charges the battery pack 16 with a high constant current for a moderate period of time, e.g., about 80 Amps for about 20 minutes. In a final stage, the Level 3 charger 30 charges the battery pack 16 using a constant voltage strategy for a relatively short period of time in order to balance the cells of the battery pack, e.g., a constant voltage charging for about 10 minutes. In general, depending on the capacity and other characteristics of the battery pack 16, the conventional Level 3 charging process can recharge the battery to about a 70-85% state of charge in about 30 minutes, with the first two stages employing constant current charging strategy and the last stage a constant voltage charging strategy.

However, the vehicle control system 24 can signal the Level 3 charger 30 via the signal line 33 to vary or deviate from the conventional charging process, for example, by requesting the Level 3 charger 30 to shift from one stage to another.

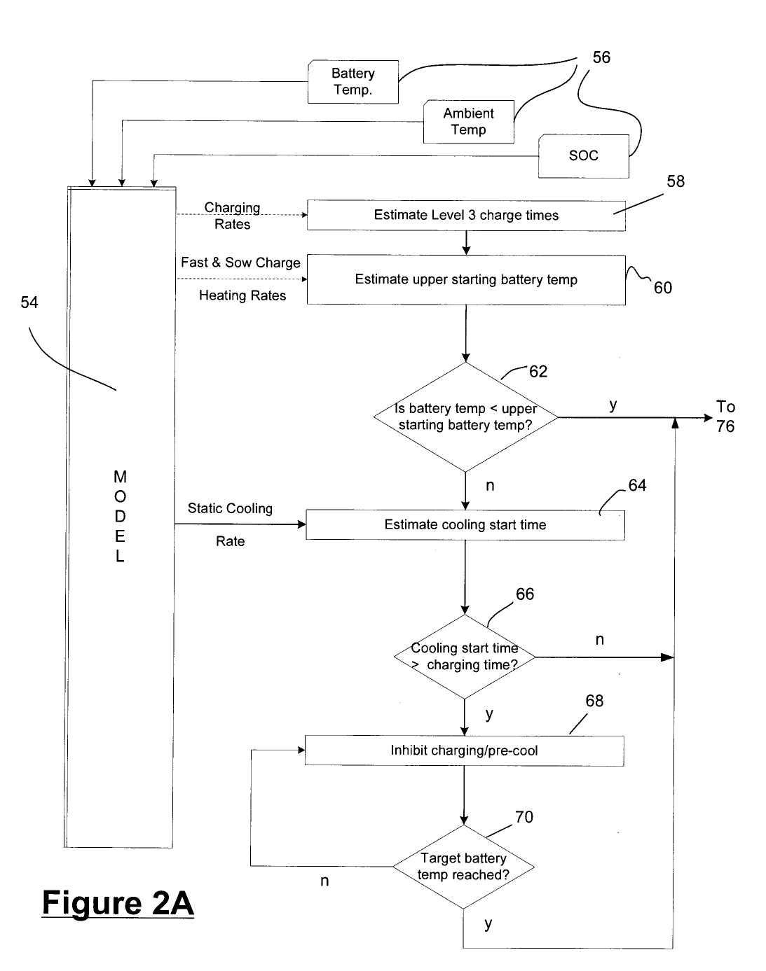

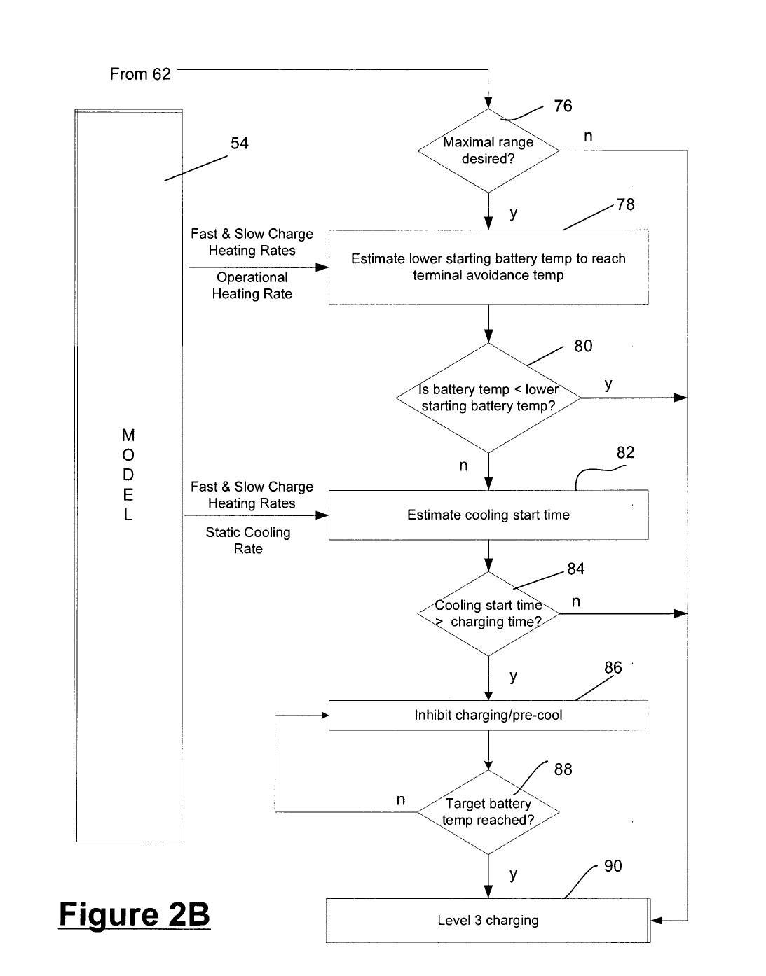

Reference is made to FIGS. 2A and 2B which together show a flowchart for carrying out a charging process 50. The charging process 50 has two main goals. The first goal is to keep the temperature of the battery pack 16 under a high threshold temperature and above a low threshold temperature to avoid inhibiting or slowing down the Level 3 charging process due to an overheated or under-heated battery pack 16 (the latter of which could result in permanent damage to a cold battery pack 16 when the cold battery pack 16 is charged at an extremely high constant current). The high threshold temperature may be, for example, about 40 degrees Celsius and the low threshold temperature may be, for example, about 10 degrees Celsius. The second goal is to provide the electric vehicle 10 with a target battery temperature at the end of Level 3 charging, which is referred to below as a terminal avoidance temperature (TAT), that will enable the electric vehicle 10 to obtain improved range in the next drive cycle after Level 3 charging.

The vehicle control system 24 stores in a memory 24M a thermal performance model 54 of the battery pack 16 and the heating/cooling subsystem 20. The model 54 may include data on a variety of battery operating characteristics, such as:

(a) fast charge heating rate: This parameter estimates the heating rate of the battery pack 16 under the high current Level 3 charging. For example, in one vehicle tested by the inventors, at an ambient air temperature of 15 degrees Celsius, with a charging current of 80 A to 125 A into a battery module, it took 2.5 minutes for the temperature of the battery module to increase by 1 degree Celsius. The heating rate at an ambient temperature of 15 degrees Celsius is thus 0.4 degrees Celsius per minutes such that over 30 minutes of constant current charging the battery module was estimated to heat up by 12 degrees Celsius. The heating rate is dependent upon the ambient temperature (the hotter the ambient temperature, the faster the rise in temperature under constant current charging) as well as the instant temperature of the battery itself (the hotter the battery, the faster the battery heats up under constant current charging).

(b) slow charge heating rate: Similar to the heating rate under constant current charging, this parameter estimates the heating rate of the battery pack 16 under low current, constant voltage charging. In general, the slow charge heating rate may be relatively low and may not cause a situation in which the battery pack requires cooling.

(c) static cooling rate: Since the electric vehicle 10 is parked at a Level 3 charging station, even if a radiator fan is running, the air circulation around the electric vehicle 10 will be worse than in comparison to when the electric vehicle 10 is driven on the road. Consequently, the heating/cooling subsystem 20 will not be running at a most efficient cooling rate. Various factors affect the cooling performance including the cooling capacity of the specific components (such as compressor and chiller) employed by the subsystem 20, the type of battery cooling method (for example, refrigerant/coolant, refrigerant/air, coolant/air, or air/air), radiator design, sun load vs. sun shed at the charging station, and other factors. However, because the electric vehicle 10 is parked and connected to a power source, the heating/cooling subsystem 20 can be run at high power and the number of variables affecting the cooling performance are reduced so that an estimate of the cooling rate provided by the heating/cooling subsystem 20 when the electric vehicle 10 is parked can be derived.

(d) charging rate: This parameter indicates the rate at which the battery pack 16 can be charged under constant current charging. For example, at a state of charge of 20%, a 125 A current can raise the state of charge by 2% in one minute. The charging rate will vary depending on the instant state of charge, the charging current, the temperature of the battery pack, the age of the battery pack and possibly other factors depending on the specifics of the battery.

(e) operational heating rate: This parameter is an estimate of the heating rate of the battery pack 16 when the electric vehicle 10 is driven a high speed, e.g., 120 km/hr, for an extended period of time. This parameter may also depend on a variety of other factors such as the ambient temperature and a ‘mode’ setting for the electric vehicle 10. The ambient temperature will determine the energy expenditure required to heat and/or cool the passenger cabin to a predetermined temperature, e.g., 21 degrees Celsius. The ‘mode’ setting will determine acceleration rates and other factors which may require greater power usage of the battery pack 16.

The operating characteristic data is initially obtained through analysis of sample parts to arrive at nominal values for these operating characteristics. In practice, the operating characteristics may be monitored throughout the life of the electric vehicle 10 and periodically adjusted in accordance with feedback from the data obtained via monitoring the operating characteristics. For example, the vehicle control system 24 may determine that the heating rate of the battery pack 16 under constant current charging may differ than the nominal rate and may use a moving average heating rate collected over a predetermined number of previous charging cycles.

At an initial step 56 of the charging process 50, the vehicle control system 24 collects operating data on the condition of the battery pack 16, such as the battery temperature, the ambient temperature and the state of charge. This data is used as an input to the battery model 54.

At a step 58, the vehicle control system 24 computes the Level 3 charge times, including the fast charge time under constant current charging and slow charge time under constant voltage charging. The charge times are estimated based on the current state of charge of the battery pack 16 and on a target state of charge. The target state of charge may be set at a predetermined value such as 80%, or may be dynamically provided by the Level 3 charger 30 or by the user. In either case, the charging time is estimated based on charging rates provided by the model 54. Alternatively, the Level 3 fast and slow charge times may be manually provided by the user.

At a step 60, the vehicle control system 24 estimates an upper starting battery temperature (USBT). The USBT is a threshold starting temperature valve for the battery pack 16 below which heating of the battery pack 16 for either the fast and slow charge times computed in step 58 would not yield a battery pack temperature during the Level 3 charge cycle that would cause the heating/cooling subsystem 20 to initiate cooling of the battery pack 16. The temperature that would cause the heating/cooling subsystem 20 to initiate cooling of the battery pack 16 may be referred to as a ‘high threshold temperature’. The USBT estimate thus depends on the fast and slow charge heating rates provided by the model 54.

For example, consider an electric vehicle that has a battery pack 16 with a high threshold temperature of 40 degrees Celsius (in an effort to keep the battery temperature below an upper operating temperature limit of 42.5 degrees Celsius). If the battery has a rate of temperature increase of 0.4 degrees Celsius/minute and the charging time is 30 minutes, then the upper starting battery temperature would be 28 degrees Celsius. Thus, if the initial temperature of the battery pack 16 is less than 28 degrees Celsius, then there would not be a need to turn on the heating/cooling subsystem 20 to keep the battery pack 16 cooler than 40 degrees Celsius during Level 3 charging. The initial temperature of the battery pack 16 may be different in a number of different example scenarios. In one scenario, the ambient temperature is 28 degrees Celsius and the driver drives the electric vehicle out of the garage at 28 degrees Celsius for a short trip to a Level 3 charging station so the temperature of the battery pack 16 does not rise much during the short trip. In another scenario, the ambient temperature is much lower than 28 degrees Celsius, but the electric vehicle 10 has just finished a long trip prior to reaching the Level 3 charging station. Thus the temperature of battery pack 16 may have been raised by several degrees Celsius and may be close to 28 degrees Celsius. In either case, if there is a higher ambient temperature or longer high speed driving cycle, the temperature of the battery pack 16 may be warmer than 28 degrees Celsius at the beginning of the fast constant current charging cycle and active thermal cooling may be required to maintain charging while preventing overheating of the battery pack 16.

At a step 62, the vehicle control system 24 compares the USBT against the instant temperature of the battery pack 16. If the instant temperature is less than the USBT control passes to step 76 in FIG. 2B. If the instant temperature is greater than the USBT, control passes to a step 64 which computes when to turn on the heating/cooling subsystem 20 in order to avoid reaching the high threshold temperature during Level 3 charging. The start time at which the heating/cooling subsystem 20 will need to be turned on (referred to as the turn on start time) will depend on the static cooling rate of the heating/cooling subsystem 20, which is provided by the model 54. At a step 66, the vehicle control system 24 compares the turn on start time of the heating/cooling subsystem 20 against the charge time and if the start time is earlier than the charge time, i.e., if it takes longer to cool than to charge, then, optionally, at steps 68 and 70 charging is initially prevented and the battery pack 16 is pre-cooled until the battery pack 16 reaches a target temperature where the Level 3 charging can begin in conjunction with cooling so as to prevent the battery pack 16 from reaching the high threshold temperature during Level 3 charging. It is alternatively possible however, that steps 66 and 68 be omitted, and for Level 3 charging to begin right away regardless of whether the battery pack 16 will require cooling at some point during the charging operation. At the point during the charging operation where cooling of the battery pack is required, the driver can be notified and can decide at that point between a plurality of options: 1.) to cool the battery pack 16 and continue charging thereafter; 2.) to cool the battery pack 16 and end the charging operation; or 3.) to not cool the battery pack 16 and end the charging operation.

The foregoing steps 56-70 relate to the first goal of keeping the temperature of the battery pack 16 below the high threshold temperature during Level 3 charging. Steps 76-88 relate to the second goal of increasing driving range after Level 3 charging.

In some scenarios, the Level 3 charging infrastructure may be built along a highway to enable electric vehicles such as vehicle 10 to undertake long road trips. Thus, with present battery technology, an assumption is made that the electric vehicle will be used for an approximately one hour high speed drive immediately after the Level 3 charging. If during the driving phase the temperature of the battery pack 16 reaches the high threshold temperature (e.g., 40 degrees Celsius), the heating/cooling subsystem 20 will need to be activated to cool the battery pack 16 during use of the vehicle 10. This will draw energy from the battery pack 16 and will thus reduce the driving range. Steps 76-88 attempt to ensure that upon termination of the Level 3 charging the temperature of the battery pack 16 is low enough that during the subsequent high speed driving stage the temperature of the battery pack 16 will not rise to the point where it is necessary to consume energy for cooling the battery pack 16.

The target temperature for the battery pack 16 at the end of the Level 3 charging which attempts to ensure that if the electric vehicle 10 is subsequently operated at a predetermined operating condition, such as being driven at a high speed for a predetermined amount of time, the temperature of the battery pack 16 during high speed driving will not rise above the high threshold temperature (which would cause the heating/cooling subsystem 20 to automatically begin to cool the battery pack 16) is referred to as the terminal avoidance temperature (TAT).

At step 76, the vehicle control system 24 determines if the second goal of obtaining increased range is desired. This step 76 may be optional in that it is assumed that the second goal is desired, but the attainment of the second goal may be subject to an input such as a specific user command or setting, or as a result of setting an electric vehicle ‘mode’ of operation where, for example, the second goal is desired when the mode is set to an ‘economy’ setting but not desired when the mode is set to a ‘sport’ setting. In the event the second goal is not desired, control passes to step 90 which commences Level 3 charging according to the parameters determined in steps 56-70, and in particular, if and when to start cooling the battery pack 16 during the Level 3 charging activity. Otherwise, control passes to a step 78.

At step 78, the vehicle control system 24 estimates the TAT and a lower starting battery temperature (LSBT). The LSBT is a threshold starting temperature below which charging of the battery pack 16 for either the fast or slow charge times computed in step 58 would not yield a temperature of the battery pack 16 that is above the TAT. The TAT depends on the operational heating rate provided by the model 54 and the LSBT depends on the fast and slow charge heating rates provided by the model 54.

For example, for the test vehicle discussed above, it is estimated that the temperature of the test vehicle battery pack 16 would increase by about 7 degrees Celsius in one hour of high speed driving at an ambient temperature of about 15 degrees Celsius. At a higher ambient temperature, the temperature of the battery pack 16 will increase quicker. Thus, the desirable temperature target for the battery pack 16 at the end of the Level 3 charging may be below 33 degrees Celsius prior to the next stage of high speed driving. The TAT is expected to be relatively low, and thus the vehicle control system 24 may need to start operating the heating/cooling subsystem 20 in order to cool the battery pack 16 early during the Level 3 charging process.

At a step 80, the vehicle control system 24 compares the LSBT against the instant temperature of the battery pack 16. If the instant temperature is less than the LSBT control passes to step 90 for commencement of the Level 3 charging. If the instant temperature is greater than the LSBT, control passes to a step 82 which computes when to turn on the heating/cooling subsystem 20 in order to avoid reaching the TAT during Level 3 charging. The turn on start time will depend on the fast and slow charge heating rates of the battery pack 16 and the static cooling rate of the heating/cooling subsystem 20, which is provided by the model 54. At a step 84, the vehicle control system 24 compares the turn on start time of the heating/cooling subsystem 20 against the charge time and if the start time is earlier than the charge time, i.e., if it takes longer to cool than to charge, then at steps 86 and 88 charging is inhibited and the battery pack 16 is pre-cooled until the battery pack 16 reaches a target temperature where the Level 3 charging can begin in conjunction with cooling so as to prevent the battery pack 16 from reaching the TAT during Level 3 charging.

Cooling the battery pack 16 while the battery pack 16 is being charged will consume energy that could have gone into recharging the battery pack 16 and thus will slow the charging process. However, because the battery pack 16 is connected to a high power source during charging, the trade off is most likely worth it. In an illustrative example, a Level 3 charging station may have a 50 kW capacity charging a battery pack 16 for 30 minutes at high constant current charging. In this example, the power consumption for running the heating/cooling subsystem 20 may be 3 kW and the heating/cooling subsystem 20 may run throughout the entire charging time of 30 minutes. The power consumed by the 3 kW heating/cooling subsystem 20 is 3/50 or 6% of the total power. This will result in an additional time of only 2 minutes spent at the charging station. However, the electric vehicle obtains the benefit of increased range which may add more than 2 minutes of high speed driving as compared to the situation where the heating/cooling system is turned on for 30 minutes during high speed driving.

In addition to the forgoing, at the initial step 56 when the vehicle control system 24 obtains the instant temperature of the battery pack 16, an additional step may be added to the process to determine if it is necessary to heat the battery pack 16. At cold temperatures (e.g., less than 10 degrees Celsius), it may be necessary to heat the battery pack 16 prior to Level 3 charging. This is because charging a cold battery with a high current such as 125 A or 80 A may cause permanent damage to the battery. Thus, the vehicle controller may need to inhibit the fast charging at the beginning and turn on the heating/cooling subsystem 20 to warm the battery pack 16 to a minimum desirable temperature. Once the minimum desirable temperature is reached, it most likely would not be required to heat the battery pack 16 after Level 3 charging begins because the heat generation from the charging will keep battery pack 16 warm for the rest of the charging process.

Those skilled in the art will understand that the flowcharts shown and described above are representative of process steps that may be practically implemented in a variety of ways, e.g., by programming one or more general purpose microcontrollers utilized in the vehicle control system 24, or through dedicated circuits that form part of the vehicle control system, or a combination of both. Further, the order of the steps shown above may be varied, other steps may be added to those shown herein, and various steps may be omitted and/or amalgamated with others.

While the above description constitutes specific examples of a charging system and/or process, these examples are susceptible to further modification and change without departing from the fair meaning of the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of disclosure.

1. A method for charging a battery pack of a vehicle, comprising:
determining an operating heating rise of the battery pack in the event the vehicle is driven at a predetermined operating condition;
obtaining a charging time to charge the battery pack;
determining a terminal avoidance temperature for the battery pack at the end of the charge time, which terminal avoidance temperature is no greater than an upper threshold temperature less the operating heating rise, wherein the upper threshold temperature is a temperature at which a cooling system of the vehicle automatically turns on to cool the battery pack; and
charging the battery pack and operating the cooling system during charging to prevent the battery pack from reaching the terminal avoidance temperature.

2. The charging method of claim 1, further including:
providing (i) a heating performance of the battery pack while under charge, (ii) the operating heating rise of the battery pack in the event the vehicle is driven at the predetermined operating condition, and (iii) a cooling performance of the cooling system in cooling the battery pack when the vehicle is parked,
and wherein the step of operating the cooling system includes:
estimating a lower starting battery temperature based on the terminal avoidance temperature less a temperature rise predicted by the heating performance of the battery pack while charging the battery pack for the duration of the charging time; and
measuring the temperature of the battery pack at the commencement of charging and, based on the lower starting battery temperature and the cooling performance of the cooling system, determining when, if at all, to operate the cooling system whilst charging to cool the battery pack.

3. The charging method of claim 2, wherein the heating performance of the battery pack is dependent on an ambient temperature and includes the steps of measuring the ambient temperature and determining the heating performance based on the ambient temperature.

4. The charging method of claim 2, wherein the heating performance of the battery pack is dependent on an instant temperature of the battery pack and includes the steps of measuring the instant temperature of the battery pack and determining the heating performance based on the instant temperature of the battery pack.

5. The charging method of claim 2, wherein the cooling performance of the cooling system is dependent on an ambient temperature and includes the steps of measuring the ambient temperature and determining the cooling performance based on the ambient temperature.

6. The charging method of claim 2, wherein the cooling performance of the cooling system is dependent on an instant temperature of the battery pack and includes the steps of measuring the instant temperature of the battery pack and determining the cooling performance based on the instant temperature of the battery pack.

7. The charging of claim 1, wherein the charger has at least a fast constant current charging phase and a slow constant voltage charging phase.

8. The charging of claim 7, wherein in the fast constant current phase the battery pack is charged with a constant current of at least 80 Amperes.

9. The charging method of claim 1, wherein the predetermined condition is driving the vehicle at a predetermined speed for a predetermined period of time.

10. A charging system for a vehicle having a battery pack driving an electric motor, the system including:
a cooling system for cooling at least the battery pack; and
a controller which determines an operating heating rise of the battery pack in the event the vehicle is driven at a predetermined operating condition, determines a charging time to charge the battery pack, and determines a terminal avoidance temperature for the battery pack at the end of the charge time, wherein the terminal avoidance temperature is no greater than an upper threshold temperature less the operating heating rise, and wherein the upper threshold temperature is a temperature at which a cooling system of the vehicle automatically turns on to cool the battery pack;
wherein the controller operates the cooling system during charging to prevent the battery pack from reaching the terminal avoidance temperature.

11. The charging system of claim 10, wherein the controller includes (i) a thermal model of a heating performance of the battery pack while under charge, (ii) the operating heating rise of the battery pack in the event the vehicle is driven at the predetermined operating condition, and (iii) a cooling performance of the cooling system in cooling the battery pack when the vehicle is parked, wherein the controller estimates a lower starting battery temperature based on the terminal avoidance temperature less a temperature rise predicted by the heating performance of the battery pack while charging the battery pack for the duration of the charging time, and wherein the controller measures the temperature of the battery pack at the commencement of charging and, based on the lower starting battery temperature and the cooling performance of the cooling system, determines if and when to operate the cooling system whilst charging to cool the battery pack.

12. The charging system of claim 10, including a charger for charging the battery pack with at least a fast constant current charging phase and a slow constant voltage charging phase.

13. The charging system of claim 12, wherein in the fast constant current phase the battery pack is charged with a constant current of at least 80 Amperes.

14. The charging system of claim 10, wherein the predetermined condition is driving the vehicle at a predetermined speed for a predetermined period of time.
